(19) United States
(12) Patent Application Publication
(10) Pub. No.: US 2018/0124516 A1
(43) Pub. Date: May 3, 2018

(54) Speaker Proximity System

(71) Applicant: Philip William Root, Boca Raton, FL (US)

(72) Inventor: Philip William Root, Boca Raton, FL (US)

(21) Appl. No.: 15/341,027

(22) Filed: Nov. 2, 2016

(51) Int. Cl. H04R 5/02; H04S 1/00

(52) U.S. Cl. CPC H04R 5/023; H04R 2430/01; H04S 1/007

(57) ABSTRACT

A speaker proximity system has a speaker having a housing and audio components located therein. The audio components have a wire attached thereto threaded through a hole in the housing and through a nearby channel. The channel is made from fabric, leather or similar flexible materials. It is also associated with a stability device that provides weight support on another side of a sofa, chair or similar device. Another speaker and channel are similarly provided and are unified within an intermediate device that integrates the both channels with the stability device.

### FIELD OF THE INVENTION

The present invention relates to a speaker system. More particularly, the present invention relates to a speaker system mounted within a unique holding device.

### BACKGROUND OF THE INVENTION

Speakers produce sound utilizing electrical energy as a means to excite vibrational motion in a speaker cone. The cone moves back and forth because a voice coil mounted with the speaker cone is attached to a source of electrical energy as well as being associated with a nearby magnet associated with the rest of the speaker components. As the applied electrical energy oscillates, the created magnetic field in the voice coil similarly changes. Further, the changing field precipitated by the electrical energy input to the voice coil literally causes the voice coil to move towards and away from the magnet; the resultant motion pushes against the surrounding air producing various sounds.

As technology has advanced numerous variations of speakers have produced speakers having unique sound characteristics including the loudspeaker, full range, woofer, sub-woofer, mid-range, tweeter, horn, electrostatic, magneto-static, plasma, digital, computer, pc and wireless speakers. However, whilst all of these have provided a great range of sound, architectural integration into a variety of architectures with the end user in mind, none of these has dealt with the simple desire to have speakers and their output sounds isolated from other users.

In other words, the desire to separate or reduce the volume to such an extent that an intended user is able to hear the sound produced therefrom without interrupting others nearby. One solution to this problem has been the ubiquitous earplugs that plug into user's ears. However, these tend to break easily and many users do not enjoy having an electronic device inserted in their ear as they cause discomfort, sanitary problems and even possible hearing loss depending upon the duration and amount of sound impacting the inner ear.

Accordingly, there needs to be some solution to the problem of a user being able to enjoy sound without bothering others and without having to physically integrate electronic devices into his or her ears.

### SUMMARY OF THE INVENTION

The present invention overcomes the deficiencies of the known art and the problems that remain unsolved by providing a method and Speaker Proximity System in accordance with the following.

A speaker proximity system comprising:
a first speaker having a first audio device therein;
a first wire attached to the first audio device such that the first wire proceeds out of the first speaker through
   a first hole in the first speaker and the first wire continue down
      a first channel circumscribing the first wire.

In another aspect, further comprising:
a second speaker having a second audio device therein;
a second wire attached to the second audio device such that the second wire proceeds out of the second speaker through
   a second hole in the second speaker and the second wire continue down
      a second channel circumscribing the second wire such that the first channel is associated with the second channel.

In another aspect, further comprising:
an intermediate device integrally attached to the first channel.

In another aspect, further comprising:
the first wire proceeding into the intermediate device.

In another aspect, further comprising:
a stability device attached to the intermediate device.

In another aspect, further comprising:
the first wire proceeding into the stability device.

In another aspect, further comprising:
an intermediate device integrally attached to the first channel and to the second channel.

In another aspect, further comprising:
the first wire and the second wire proceeding into the intermediate device.

In another aspect, further comprising:
a stability device attached to the intermediate device.

In another aspect, further comprising:
the first wire and the second wire proceeding into the stability device.

A speaker system comprising:
a counterweight device attached to
a middle portion integral with
a first channel device.

In another aspect, further comprising:
a first speaker associated with the first channel device.

In another aspect, further comprising:
a power actuation device on a portion of the speaker.

In another aspect, further comprising:
a volume actuation device on a portion of the speaker.

In another aspect, further comprising:
a second channel device attached to the middle portion on an opposite side of the middle portion as the first channel device.

In another aspect, further comprising:
a second channel device attached to the middle portion on an opposite side of the middle portion as the first channel device;
a second speaker associated with the second channel device.

In another aspect, further comprising:
a power actuation device on a portion of the speaker.

An audio relaxation assembly comprising:
a middle integration device placed between
a first tubular device and
a second tubular device; wherein the middle integration device has
a counterweight device integrally attached thereto.

In another aspect, the audio relaxation assembly further comprising:
a first speaker associated with the first tubular device and
a second speaker associated with the second tubular device.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 presents a Speaker Proximity System for enjoying the sound produced in an embodiment taught herein.

FIG. 2 presents a Speaker Device utilized in a Speaker Proximity System as taught in an embodiment herein disclosed.

FIG. 3 presents the Speaker Electrical and Mechanical Components used in the Speaker Proximity System as taught in an embodiment herein disclosed.

FIG. 4A presents a Channel Device having an internal stiffener device in an embodiment disclosed herein.

FIG. 4B presents a Channel Device having an internal stiffener device in an embodiment disclosed herein.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

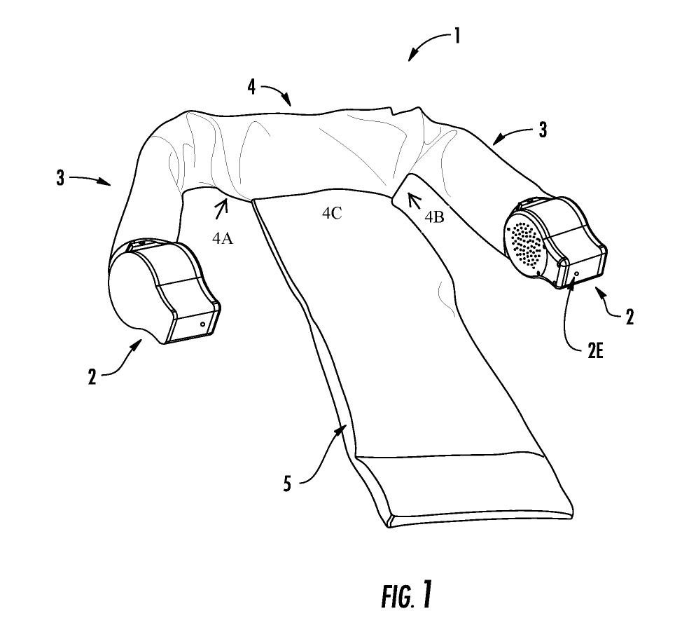

FIG. 1 presents a Speaker Proximity System for enjoying the sound produced in an embodiment taught herein. A Speaker Proximity System 1 is shown having two speakers 2, two channels 3, an intermediate device 4 , a stability device 5. The Speaker Proximity System 1 is designed for use on a sofa, sofa chair, chair or similar such sitting system. When in use the stability device 5 is placed on the rear portion of a sofa, sofa chair, chair or similar sitting system so as to balance the weight of the other components; these other components, namely, the speakers 2, the two channels 3 and the intermediate device 4 are disposed on the front portion of the sofa, sofa chair, chair or similar sitting system thereby balancing out the rear portion stability device 5. The stability device 5 also performs the function of having an interior open portion therein for the threading of the electrical wires necessary to arrive at a radio, music box, cd player, mobile device, cell phone or similar device therethrough and through a suitable hole in the stability device for a similar purpose.

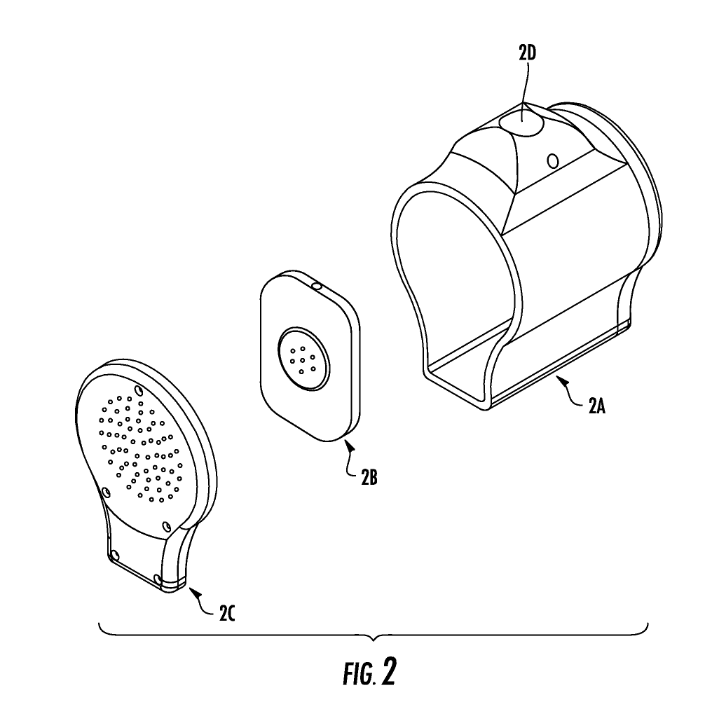

The speakers 2 are oriented so that their audio output faceplate is directed towards the user who would sit there between. There is a rotating power, volume knob 2E that has appropriate circuitry for actuating these functions and it is located on a side plate of the speaker 2 within a hole therein appropriate for reception and mounting of this knob. It also has control wires that are attached to the back of the rotating power, volume knob and that extend to and are attached to the audio device 2B shown in FIG. 2.

The wiring of each speaker exits the speaker through a hole at its back portion and is threaded up a corresponding channel 3 on each side of the Speaker Proximity System. This channel 3 is simply a longitudinal strip of material having four sides: two long sides and two short sides. By bringing the two long sides together it is subsequently united along its edge by sewing, heat gluing, or similar method. As a result, a cylinder is created creating a channel for the procession therethrough of the wiring for the speaker; this wiring first enters a first circular mouth formed at a first end of the longitudinal channel by the first short side and exits the second end of the longitudinal channel formed by the second short side through a similar formed second circular mouth.

The second circular mouth of each channel 3 integrates along its edge by sewing, heat treatment, gluing, or similar methods with one of two corresponding intermediate device openings found on either side of the intermediate device 4. The wiring of either speaker 2 enters one or the other intermediate device 4 opening and proceeds therethrough. The intermediate device 4 itself, is like the channel 3 a similar longitudinal strip of material having four sides: two long sides and two short sides. However, in this instance the longitudinal sides are brought together along only at a first portion 4A and a second portion 4B of the longitudinal sides which are united by sewing, gluing, heat treatment or similar methods; this leaves an exit region 4C there between open for the acceptance of wiring from the first and second speaker to proceed therethrough. Also, as the two longitudinal sides are brought together, the two short sides form intermediate device openings that are integrated each one with one of the second circular mouths of the channels 3 by sewing, heat treatment and so forth.

This exit region of the intermediate device is disposed in such a fashion that it is connected by sewing, gluing or heat treatment to the stability device 5. The stability device is a rectangular strip of material that both stabilizes the entire Speaker Proximity System 1 and provides the final egress of the speaker wiring. The stability device 5 is simply a longitudinal strip of material having four sides: two long sides and two short sides. By bringing the two long sides together it is subsequently united along these long edges by sewing, heat gluing, or similar method. As a result, a rectangular space is created therein for the procession therethrough of the wiring for the speakers. The first short side of stability device 5 having been folded over to form a rectangular space therein along with the long sides has top and bottom portions (from a short side folded) that are connected to similar top and bottom portions of the intermediate device 4 in the exit region 4C thereof.

Both the first short side and the second short side create a mouth for the ingress (first short side connected to exit region) and egress (second short side) therethrough of the speakers' wiring. The stability device has optional sand or gel weights (sand or gel in a plastic container) inserted and sewn therein or alternatively placed in an appropriate internal pocket. Further, this weight(s) is alternatively permanently sewn into an extension 5A of the stability device which is simply a small end portion of the original that has been blocked off along a sewing line forming a permanent pocket for this purpose.

FIG. 2 presents a Speaker Device utilized in a Speaker Proximity System as taught in an embodiment herein disclosed. A speaker 2 as taught herein has three main components including a housing 2A, an audio device 2B, and a faceplate 2C. A hole 2D on the back of speaker housing is provided for the placement therethrough of the wiring for the audio device 2B. This audio device can be anything such as a regular speaker having a cone, magnet, voice coil, electrical contacts, support structure, and other devices having typical components comprising speaker systems.

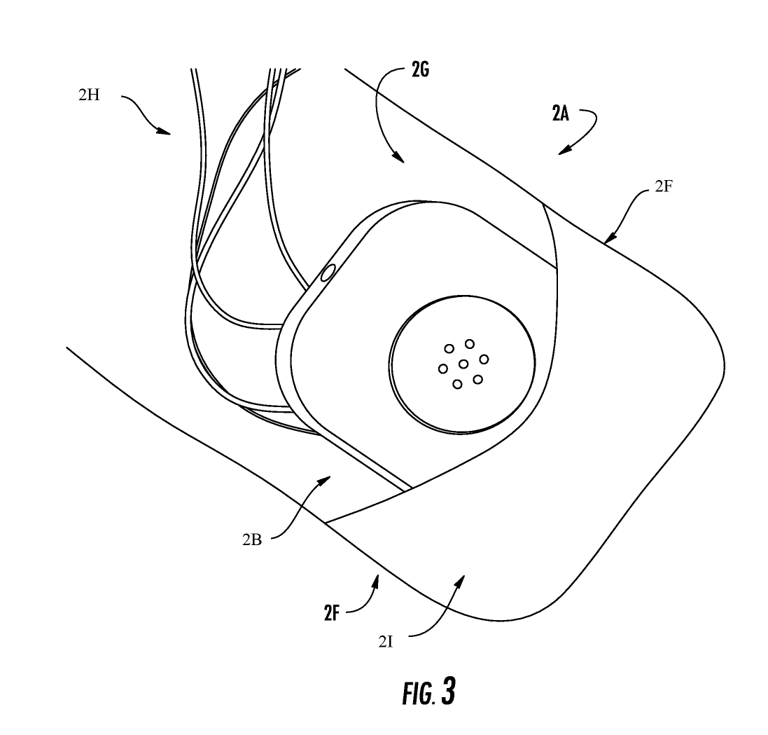

FIG. 3 presents the Speaker Electrical and Mechanical Components used in the Speaker Proximity System as taught in an embodiment disclosed herein. The housing 2A of speaker 2 has an internal mounting region 2G wherein an audio device 2B can be placed. This mounting region 2G is formed by placing a piece of material 2I between interior surfaces of the speaker housing 2A. This piece of material 2I is as simple as a piece of flexible nylon, weaved, leather or other similar material attached internally to suitable portion of the internal narrow side surfaces (in this example) of the speaker 2; alternatively, it is a plastic region formed to create a pocket 2G for the placement therein of the audio device 2B.

The ends 2F of each flexible material or plastic material 2I are attached internally to interior sides of the narrow portion of the speaker housing in this example. Also, the piece of material forming the forward boundary of the pocket 2G bows outwards towards the open faceplate 2C thus forming this pocket 2G. The bottom portion of the flexible material or plastic material 2I is attached to the bottom narrow surface of the speaker housing 2A as shown. Wiring 2H proceeds from the audio device 2B through the hole 2D in the speaker housing up the channel 3 and on into the intermediate device 4 and down the stability device 5. A suitable orifice in the stability device permits exit of these wires 2H so that they can appropriately attached to an amplifier device. It should be appreciated that the audio device 2B is also able to be controlled via wifi if so desired so as to engage various music, stations, waves, and so forth; thus, both wired and or wireless control is possible.

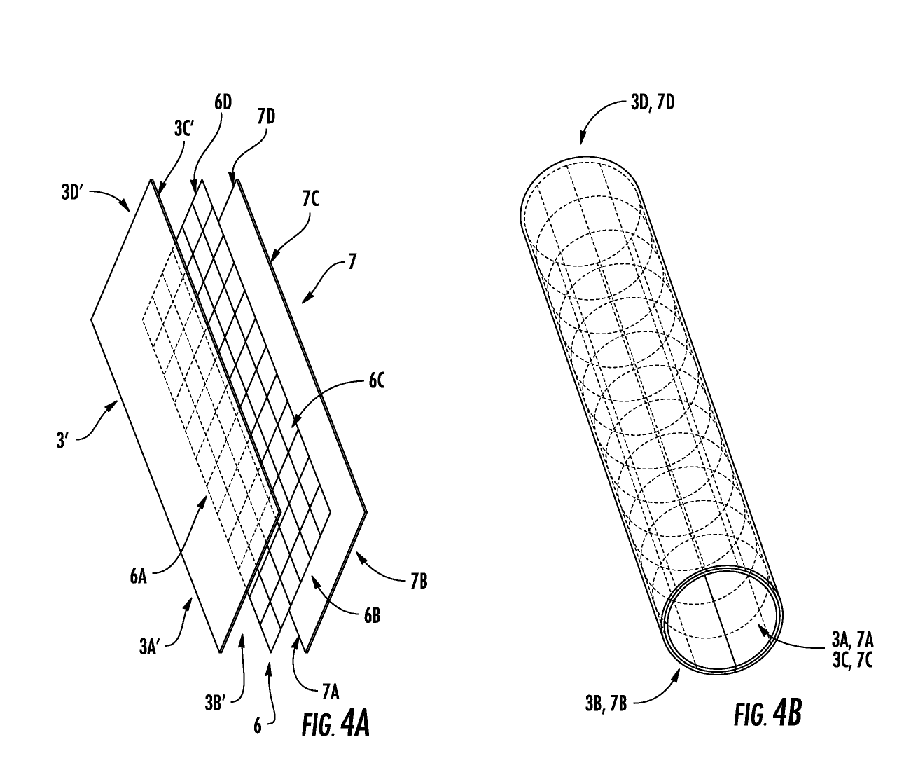

FIG. 4A presents an alternative Channel Device having an internal stiffener device in an alternative embodiment disclosed herein. An alternative channel device is shown with various sub components exposed so that the various features thereof are more clearly visible. The alternative channel device is composed of first and second piece of material 3′, 7, such as leather, vinyl, fabric or similar material having a stiffener material sewn there between. A first piece of material 3′ has a bottom portion 3A′, a front portion 3B′, a top portion 3C′, a back portion 3D′ that correspond with similar features of the second piece of material 7 that itself has a bottom portion 7A, a front portion 7B, a top portion 7C, a back portion 7D.

Thus, to accomplish this, the bottom portion 3A is sewn to the bottom portion 7A; then, the front portion 3B is sewn to the front portion 7B. Similarly, the top portion 3C is sewn to the top portion 7C and the back portion 3D is sewn to the back portion 7D and so forth. It should be apparent that the two external pieces of material 3, 7 are of similar size and act to encapsulate any other material that is held there between.

Additionally, a stiffener material metallic wire, chicken wire, or similar wire mesh 6 has various cavities therein; these cavities serve for the attachment of sewing threads and or sewn strips of material from one or both pieces of material 3′, 7 through the cavities and back to the original starting piece of material or over to the other piece of material locking these together. The ultimate pattern of sewing is up to the manufacturer so long as the final effect is to tightly engage the stiffener material 6 within the two external pieces of material 3′, 7. However, it should be flexible enough that a user can actuate the wire, wire mesh or chicken wire in such a fashion that it holds a particular location for a user to enjoy the sound therefrom. The mesh 6 has a a bottom portion 6A, a front portion 6B, a top portion 6C, a back portion 6D.

FIG. 4B presents a Channel Device having an internal stiffener device in an alternative embodiment disclosed herein. Once the stiffener material 6 is firmly enclosed within the two pieces of material 3, 7, then the junction between 3C, 7C is brought together with the junction between 3A, 7A and sewn together. Thus, a tubular structure is created forming a channel that is easily manipulable by a user and that holds its disposition because of the internally enclosed stiffener 6.

Final Considerations: The device materials such as the channel 3, alternative channel 3′, 6, 7 and various other portions for example 4, 5 that are made of flexible materials are designed to blend into the sofa, chair or other external surface of the sitting device upon which it rests. Thus, it is contemplated that if one were to use the device on a leather chair then such would be a good material choice for these materials; similarly, cloth, satin, and so on.

What is claimed is:

1. A speaker proximity system comprising:
a first speaker having a first audio device therein;
a first wire attached to the first audio device such that the first wire proceeds out of the first speaker through
a first hole in the first speaker and the first wire continue down
a first channel circumscribing the first wire.

2. The speaker proximity system of claim 1, further comprising:
a second speaker having a second audio device therein;
a second wire attached to the second audio device such that the second wire proceeds out of the second speaker through
a second hole in the second speaker and the second wire continue down
a second channel circumscribing the second wire such that the first channel is associated with the second channel.

3. The speaker proximity system of claim 1, further comprising:
an intermediate device integrally attached to the first channel.

4. The speaker proximity system of claim 3, further comprising:
the first wire proceeding into the intermediate device.

5. The speaker proximity system of claim 3, further comprising:
a stability device attached to the intermediate device.

6. The speaker proximity system of claim 5, further comprising:
the first wire proceeding into the stability device.

7. The speaker proximity system of claim 2, further comprising:
an intermediate device integrally attached to the first channel and to the second channel.

8. The speaker proximity system of claim 7, further comprising:
the first wire and the second wire proceeding into the intermediate device.

9. The speaker proximity system of claim 8, further comprising:
a stability device attached to the intermediate device.

10. The speaker proximity system of claim 9, further comprising:
the first wire and the second wire proceeding into the stability device.

11. A speaker system comprising:
a counterweight device attached to
a middle portion integral with
a first channel device.

12. The speaker system of claim 11, further comprising:
a first speaker associated with the first channel device.

13. The speaker system of claim 12, further comprising:
a power actuation device on a portion of the speaker.

14. The speaker system of claim 12, further comprising:
a volume actuation device on a portion of the speaker.

15. The speaker system of claim 11, further comprising:
a second channel device attached to the middle portion on an opposite side of the middle portion as the first channel device.

16. The speaker system of claim 12, further comprising:
a second channel device attached to the middle portion on an opposite side of the middle portion as the first channel device;
a second speaker associated with the second channel device.

17. The speaker system of claim 16, further comprising:
a power actuation device on a portion of the speaker.

18. The speaker system of claim 16, further comprising:
a volume actuation device on a portion of the speaker.

19. An audio relaxation assembly comprising:
a middle integration device placed between
a first tubular device and
a second tubular device; wherein the middle integration device has
a counterweight device integrally attached thereto.

20. The audio relaxation assembly further comprising:
a first speaker associated with the first tubular device and
a second speaker associated with the second tubular device.
